(19) United States
(12) Patent Application Publication
(10) Pub. No.: US 2014/0189063 A1
(43) Pub. Date: Jul. 3, 2014

(54) CONTENT DELIVERY VIA AN ONLINE SYNCHRONIZED CONTENT MANAGEMENT SYSTEM

(71) Applicant: Dropbox, Inc., San Francisco, CA (US)

(72) Inventor: Thomas Carriero, San Francisco, CA (US)

(73) Assignee: Dropbox, Inc., San Francisco, CA (US)

(21) Appl. No.: 13/728,406

(22) Filed: Dec. 27, 2012

(51) Int. Cl. H04L 29/08

(52) U.S. Cl. CPC H04L 67/02
USPC 709/219

(57) ABSTRACT

Systems, methods, and computer-readable media for content delivery. The system first receives subscription information associated with an account. Next, the system detects a content delivery triggering event, wherein the content delivery triggering event triggers a delivery of a next content item selected for delivery based at least in part on the subscription information. In response to the content delivery triggering event, the system then delivers the next content item to the account, wherein the account is configured to synchronize with a device associated with the account. The system can synchronize with the device to deliver the next content item to the device.

### TECHNICAL FIELD

The present technology pertains to content delivery, and more specifically pertains to automatically delivering content for a user of an online account.

### BACKGROUND

During the early 20^{th} Century, the principal way people were able to listen to music was with a vinyl record. Now, people are able to listen to music or watch a movie from their mobile phones, personal players, and laptop computers, by simply playing a digital file stored on the device or downloaded from a remote server. Moreover, users can conveniently stream digital files to their mobile device from the Internet, and access the digital files directly from their mobile device. This remarkable convenience and availability of online content has caused the market for online content to become widespread. For example, sales of downloaded music have surpassed sales of physical media in many markets throughout the world. The Internet and the rise of mobile media devices are often cited as the catalyst behind this digital-content surge.

Capitalizing on the digital-content surge, online content providers blazed a trail for user consumption of online content. Online content providers gave users access to extensive catalogs of online content, where users can easily purchase, download, and stream content from any device connected to the Internet. Access to such catalogs of online content has only grown steadily with the increase and variety of digital content and Internet capabilities of personal devices, such as mobile phones, portable media players, and laptop computers, which allow users to purchase, download, and stream content from virtually anywhere. In addition, the rising use of personal devices and the increased access to catalogs of online content has precipitated a growing demand for online content and a strong reliance by users on online content providers.

Typically, content obtained from an online provider is downloaded and stored on the device used to download the content. Alternatively, content from an online provider can simply be streamed to the device for playback. In both cases, the user must select the content to be downloaded or streamed when the user wishes to access content from an online provider. Thus, the content is not immediately available to the user when the user desires to access it, as the user must first initiate the download or streaming process, and wait for the process to complete. Yet this process can be tedious, as searching for content and downloading or streaming the searched content can be time-consuming. Moreover, the user must often wait for the content to download, before the content is accessible to the user. And current solutions do not otherwise automate the process of identifying content for the user and downloading the content to the user device.

### SUMMARY

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out hereinafter. These and other features of the disclosure will become more fully apparent from the following description and accompanying drawings, or can be learned by the practice of the principles set forth herein.

The approaches set forth herein can be used to automatically deliver content to a user. An account on a system can be used to maintain subscription information for a user. The subscription information can be used by the system to automatically deliver content to the user. The system can use the subscription information to determine what content to deliver to the user, when to deliver the content to the user, where to obtain the content to deliver to the user, how to request the content for delivery to the user, etc. The system can also use other information on the account to deliver content to the user, such as account preferences, user details, content history, etc. The user can have content automatically downloaded to the user's device without any effort by the user. For example, the system can automatically download items from a collection of content items to the user device as the items are released and/or become available for access. The user can thus have desired content automatically available at her device without having to spend time searching for and downloading content. The process can be seamless and transparent to the user.

Disclosed are systems, methods, and non-transitory computer-readable storage media for content delivery. The system can first receive subscription information associated with a user account. The subscription information can include a queue, a content history, a content preference, a content rating, a content ranking, a content identification, a content type, a content category, a content recommendation, a content selection, and so forth. For example, the subscription information can also include a list of content items identified for delivery to the device associated with the user account. The subscription information can also include information about a user associated with the user account. Information about the user can include user preferences, user details, user options, user-defined conditions, user lists, user device information, user membership, usage information, synchronization settings, user storage information, user permissions, etc.

Moreover, the subscription information can be edited or modified after being received by the system. For example, the subscription information can be modified based on input from a user associated with the user account. In some aspects, a subscription menu can be transmitted to a device associated with the user account for presentation at the device. A user can then use the subscription menu to provide updated subscription information. The system can receive the updated subscription information provided by the user and use that information to modify the subscription information. This way, a user associated with the user account can manage the subscription information at any time. For example, the user can submit to the system, via the subscription menu, user management options having user-defined conditions for delivery of content items. The system can receive the user management options with the user-defined conditions for delivery of content items, and modify the subscription information based on the user management options. The system can then use the user-defined conditions from the subscription information to later determine when to deliver content items to the user account and/or a user device, what content items to deliver, etc.

Next, the system can detect an event that triggers delivery of a content item, wherein the content item is selected for delivery based on the subscription information. The content item can include a video, a document, an image, an audio file, metadata, captions, software, revisions to a previously stored content item, a collection of files, a folder, an executable file, and so forth. For example, the content item can be an article, a song or a music album, a movie, a television episode from a television series, an electronic game, a software patch, etc. Moreover, the event can trigger the delivery of the content item automatically, without input from a user.

The event can include a scheduled delivery instruction, a removal of a content item from the user account, an indication that the content item in the user account has been accessed by a user associated with the user account, an indication that the user has finished accessing the content item in the user account, a request from the user, an indication that a user has shared content with the user account, an indication that the user account has sufficient storage space for the next content item, and/or a dequeuing operation. For example, the event can be a signal indicating that the content item is available in a queue of content items scheduled for delivery to the user account and/or a device associated with the user account. As another example, the event can be an indication that a content item has been removed from the user account, thus freeing storage space for the content item on the user account and/or opening a delivery slot or position for the content item. The event can also include a release of the content item, such as a release for sale, a release for public consumption, a release from a hold, a release for distribution, a release from use, a release per an agreement, etc.

After detecting the event, the system can deliver the content item to the user account, wherein the user account is configured to synchronize with a device associated with the user account. The user account can then synchronize with the device associated with the user account to deliver the content item to the device. The system can deliver the content item to the user account automatically, without input from a user associated with the user account. Similarly, the user account can synchronize with the device automatically, without input from the user. This way, the user can have content items downloaded/delivered to the user's device automatically. Here, the user does not have to spend time initiating a download and waiting for the download to complete in order to access the content item from her device when the user so desires.

Content shared between users also can be automatically delivered to the user account. For example, a user can share a video with another user associated with the account and have that video automatically delivered to the other user's device for access by the other user. Here, the system can detect the user's request to share the video as a triggering event. In response to the user's request to share the video, the system can automatically deliver the video to the user account. The account can then synchronize the video to the other user's device so the video is automatically delivered to the other user's device. The user can receive the video at her user device without taking any action to accept the shared video (in other words, the content is automatically “pushed” to the other user's device). However, the user can also control the delivery and sharing of content through various settings (e.g., file type, sharing user, file size, account type, timing, date, etc.) so that only certain shared content is automatically delivered to the user account and/or user's device. For example, a parent can setup their account to only automatically accept/download content shared by their kids.

The system can also remove content items from the account in response to a cleanup triggering event. The cleanup triggering event can trigger the cleanup and/or removal of content from the account to manage the content stored and accessible on the account. The cleanup process can help manage the space used by content on the account, restrict access to content on the account, free-up resources used by the account, update or replace content on the account, organize content on the account, etc. The cleanup triggering event can include an alert based on an expiration, an alert based on a date/schedule, a cleanup instruction, a status signal, a command, a delete request, an indication of a capacity limit, an indication of a resource status, an indication of an account status and/or restriction, a delete instruction based on a profile, a delete instruction based on a cleanup policy, a delete instruction based on a content subscription, an indication based on a flag and/or tag, a user input, etc.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 shows an exemplary configuration of devices and a network in accordance with the invention;

FIG. 2 shows an example method for content delivery;

FIG. 3 shows an example method for receiving content;

FIG. 4 shows an example method for content delivery from an account;

FIG. 5 shows an example method for initiating content delivery;

FIG. 6 shows an example method for content delivery from a content server;

FIG. 7A shows a conventional system bus computing system architecture; and

FIG. 7B shows a computer system having a chipset architecture.

### DESCRIPTION

Various embodiments of the disclosure are discussed in detail below. While specific implementations are discussed, it should be understood that this is done for illustration purposes only. A person skilled in the art will recognize that other components and configurations may be used without departing from the spirit and scope of the disclosure.

The disclosed technology addresses the need in the art for automatic content delivery. The approaches set forth herein can be used to automatically deliver content to a user. An account on a content-management system can be used to maintain information about the user, which the content-management system can then use to seamlessly deliver content to the user. The content-management system can use the account to manage content for the user and efficiently determine what content to deliver to the user, and when to deliver the content to the user. The content-management system can use subscription information to automatically select the content to deliver, obtain the content from a storage resource or a third party provider, and deliver the content to the user. The content-management system can automatically deliver the content to the user at a device associated with the account on the content-management system.

Moreover, the content-management system can obtain content for the user without the user's input, and synchronize with the user's device to seamlessly deliver the content to the user. This way, the user can quickly access content on the user's device, without having to initiate the delivery of the content and wait for the process to complete. The user can have content automatically available at the user's device as the content becomes available for consumption. The account can maintain a queue of content for the user, and automatically deliver the content to the user in the order prescribed by the queue. The system can automatically deliver items in a collection of content items to the user as the items become available and/or as prompted by a rule or condition. For example, the system can automatically deliver episodes in a television series to the user as new episodes are released. The user can therefore have all of her favorite television episodes transparently and automatically downloaded to her device without any effort.

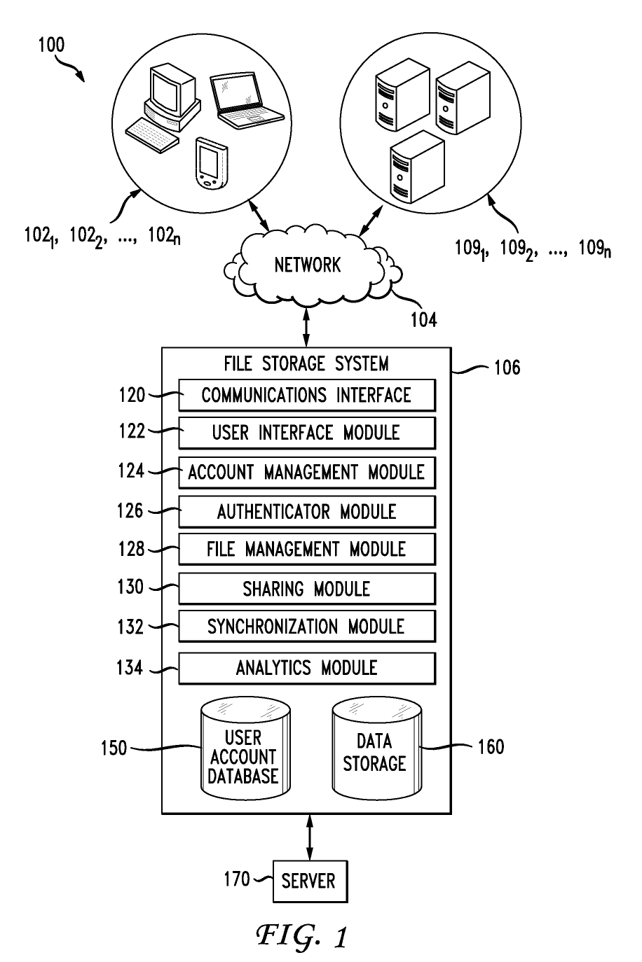

An exemplary system configuration 100 is shown in FIG. 1, wherein electronic devices communicate via a network for purposes of exchanging content and other data. The system can be configured for use on a wide area network such as that shown in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, a user can interact with content management system 106 through client devices 102₁, 102₂, . . . , 102ₙ (collectively “102”) connected to network 104 by direct and/or indirect communication. Content management system 106 can support connections from a variety of different client devices, such as desktop computers; mobile computers; mobile communications devices, e.g. mobile phones, smart phones, tablets; smart televisions; set-top boxes; and/or any other network enabled computing devices. Client devices 102 can be of varying type, capabilities, operating systems, etc. Furthermore, content management system 106 can concurrently accept connections from and interact with multiple client devices 102.

A user can interact with content management system 106 via a client-side application installed on client device 102ᵢ. In some embodiments, the client-side application can include a content management system specific component. For example, the component can be a stand-alone application, one or more application plug-ins, and/or a browser extension. However, the user can also interact with content management system 106 via a third-party application, such as a web browser, that resides on client device 102ᵢ and is configured to communicate with content management system 106. In either case, the client-side application can present a user interface (UI) for the user to interact with content management system 106. For example, the user can interact with the content management system 106 via a client-side application integrated with the file system or via a webpage displayed using a web browser application.

Content management system 106 can make it possible for a user to store content, as well as perform a variety of content management tasks, such as retrieve, modify, browse, and/or share the content. Furthermore, content management system 106 can make it possible for a user to access the content from multiple client devices 102. For example, client device 102ᵢ can upload content to content management system 106 via network 104. The content can later be retrieved from content management system 106 using the same client device 102ᵢ or some other client device 102.

To facilitate the various content management services, a user can create an account with content management system 106. The account information can be maintained in user account database 150. User account database 150 can store profile information for registered users. In some cases, the only personal information in the user profile can be a username and/or email address. However, content management system 106 can also be configured to accept additional user information.

User account database 150 can also include account management information, such as account type, e.g., free or paid; usage information, e.g., file edit history; maximum storage space authorized; storage space used; content storage locations; security settings; personal configuration settings; content sharing data; etc. Account management module 124 can be configured to update and/or obtain user account details in user account database 150. The account management module 124 can be configured to interact with any number of other modules in content management system 106.

An account can be used to store content, such as documents, text files, audio files, video files, etc., from one or more client devices 102 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 160. Content storage 160 can be a storage device, multiple storage devices, or a server. Alternatively, content storage 160 can be a cloud storage provider or network storage accessible via one or more communications networks. Content management system 106 can hide the complexity and details from client devices 102 so that client devices 102 do not need to know exactly where the content items are being stored by content management system 106. In one variation, content management system 106 can store the content items in the same folder hierarchy as they appear on client device 102ᵢ. However, content management system 106 can store the content items in its own order, arrangement, or hierarchy. Content management system 106 can store the content items in a network accessible storage (SAN) device, in a redundant array of inexpensive disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various accounts, folders, or groups. The metadata for a content item can be stored as part of the content item or can be stored separately. In one variation, each content item stored in content storage 160 can be assigned a system-wide unique identifier.

Content storage 160 can decrease the amount of storage space required by identifying duplicate files or duplicate segments of files. Instead of storing multiple copies, content storage 160 can store a single copy and then use a pointer or other mechanism to link the duplicates to the single copy. Similarly, content storage 160 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 106 can be configured to support automatic synchronization of content from one or more client devices 102. The synchronization can be platform agnostic. That is, the content can be synchronized across multiple client devices 102 of varying type, capabilities, operating systems, etc. For example, client device 102ᵢ can include client software, which synchronizes, via a synchronization module 132 at content management system 106, content in client device 102ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 106. Conversely, the background process can identify content that has been updated at content management system 106 and synchronize those changes to the local folder. The client software can provide notifications of synchronization operations, and can provide indications of content statuses directly within the content management application. Sometimes client device 102ᵢ may not have a network connection available. In this scenario, the client software can monitor the linked folder for file changes and queue those changes for later synchronization to content management system 106 when a network connection is available. Similarly, a user can manually stop or pause synchronization with content management system 106.

A user can also view or manipulate content via a web interface generated and served by user interface module 122. For example, the user can navigate in a web browser to a web address provided by content management system 106. Changes or updates to content in the content storage 160 made through the web interface, such as uploading a new version of a file, can be propagated back to other client devices 102 associated with the user's account. For example, multiple client devices 102, each with their own client software, can be associated with a single account and files in the account can be synchronized between each of the multiple client devices 102.

Content management system 106 can include a communications interface 120 for interfacing with various client devices 102, and can interact with other content and/or service providers 109₁, 109₂, . . . , 109ₙ (collectively “109”) via an Application Programming Interface (API). Certain software applications can access content storage 160 via an API on behalf of a user. For example, a software package, such as an app on a smartphone or tablet computing device, can programmatically make calls directly to content management system 106, when a user provides credentials, to read, write, create, delete, share, or otherwise manipulate content. Similarly, the API can allow users to access all or part of content storage 160 through a web site.

Content management system 106 can also include authenticator module 126, which can verify user credentials, security tokens, API calls, specific client devices, and so forth, to ensure only authorized clients and users can access files. Further, content management system 106 can include analytics module 134 that can track and report on aggregate file operations, user actions, network usage, total storage space used, as well as other technology, usage, or business metrics. A privacy and/or security policy can prevent unauthorized access to user data stored with content management system 106.

Content management system 106 can include sharing module 130 for managing sharing content publicly or privately. Sharing content publicly can include making the content item accessible from any computing device in network communication with content management system 106. Sharing content privately can include linking a content item in content storage 160 with two or more user accounts so that each user account has access to the content item. The sharing can be performed in a platform agnostic manner. That is, the content can be shared across multiple client devices 102 of varying type, capabilities, operating systems, etc. The content can also be shared across varying types of user accounts.

In some embodiments, content management system 106 can include a content management module 128 for maintaining a content directory. The content directory can identify the location of each content item in content storage 160. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 106 can use the content path to present the content items in the appropriate folder hierarchy.

A content entry can also include a content pointer that identifies the location of the content item in content storage 160. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 130 can be configured to add a user account identifier to the content entry associated with the content item, thus granting the added user account access to the content item. Sharing module 130 can also be configured to remove user account identifiers from a content entry to restrict a user account's access to the content item.

To share content publicly, sharing module 130 can be configured to generate a custom network address, such as a uniform resource locator (URL), which allows any web browser to access the content in content management system 106 without any authentication. To accomplish this, sharing module 130 can be configured to include content identification data in the generated URL, which can later be used to properly identify and return the requested content item. For example, sharing module 130 can be configured to include the user account identifier and the content path in the generated URL. Upon selection of the URL, the content identification data included in the URL can be transmitted to content management system 106 which can use the received content identification data to identify the appropriate content entry and return the content item associated with the content entry.

In addition to generating the URL, sharing module 130 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 130 can be configured to change the value of the flag to 1 or true after generating a URL to the content item.

In some embodiments, sharing module 130 can also be configured to deactivate a generated URL. For example, each content entry can also include a URL active flag indicating whether the content should be returned in response to a request from the generated URL. For example, sharing module 130 can be configured to only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing module 130 can reactivate the URL by again changing the value of the URL active flag to 1 or true. A user can thus easily restore access to the content item without the need to generate a new URL.

System 100 can also include content server 170. Content server 170 can be part of content management system 106 or a third-party content provider. Content server 170 can deliver content to an account on the content management system 106. Content server 170 can be a content server, an account server, a service provider, a storage server, a network device, a user device, a media server, an online content store, an online content repository, a file server, a virtual server, a cloud server, etc. Content server 170 can deliver the content to the account through direct and/or indirect communication. For example, content server 170 can deliver the content to the account via a network, such as network 104. A content item delivered by content server 170 can include a video, a document, an image, an audio file, a folder, metadata, captions, software, revisions to a content item, a collection of files, etc. Content management system 106 can store the content received from content server 170 for the account, as previously described. Content server 170 can deliver the content to the account in response to a triggering event.

A triggering event can trigger delivery of content from content server 170 to the account, and/or from the account to one or more client devices 102. A triggering event can also trigger content management system 106 to request delivery of content from content server 170. Moreover, a triggering event can be received and/or detected at content management system 106 and/or content server 170.

A triggering event can include a delivery instruction, such as a scheduled delivery instruction; an alert, such as a timing alert, a scheduled alert, an availability alert, a resource alert, an availability alert, a sequencing or ordering alert, an operation alert, a status alert, etc.; a signal, such as a placement signal, an activity signal, a request signal, a control signal, etc.; a removal of content from the account; an indication that content in the account has been accessed by a user; an indication that a user has finished accessing content in the account; a request from a user or device; a command; an indication that the account has sufficient storage space for additional content; an indication that a user has shared content to be delivered to the account, a dequeuing operation; etc. For example, a triggering event can include a signal indicating that a particular content item is next in a queue of content items scheduled for delivery to the account. As another example, a triggering event can be an indication that a content item has been deleted from the account, thus freeing space on the account for more content and/or activating a delivery slot or position in a queue of content to be delivered to the account. A triggering event can also include a product release; a release notice, such as a notice that content has been made available for purchase and/or download; a release from a hold; a release from use by a user, device, account, and/or resource; a release agreement, etc.

Content management system 106 can also detect and/or receive a cleanup event to initiate a cleanup and/or removal of content in the account. A cleanup event can then trigger the cleanup and/or removal of content in the account. Accordingly, content management system 106 can remove content from the account in response to the cleanup event. The cleanup and/or removal of content from the account can help content management system 106 or a user manage the content stored and accessible in the account. The cleanup process can also help manage the amount of space used by the content in the account, restrict access to content in the account, free-up resources in content management system 106, update or replace content in the account, organize content in the account, etc.

Moreover, a cleanup event can include an alert based on an expiration, an alert based on a date/schedule, a cleanup instruction, a status signal, a command, a delete request, an indication of a capacity limit, an indication of a resource status, an indication of an account status and/or restriction, a delete instruction based on a profile, a delete instruction based on a cleanup policy, a delete instruction based on a content subscription, an indication based on a flag and/or tag, a user input, etc. For example, a cleanup event can be an alert generated by account management module 124, based on subscription information stored on user account database 150, indicating that content on the account has expired due to a restriction on a user's subscription.

While content management system 106 is presented with specific components, it should be understood by one skilled in the art, that the architectural configuration of system 106 is simply one possible configuration and that other configurations with more or less components are also possible.

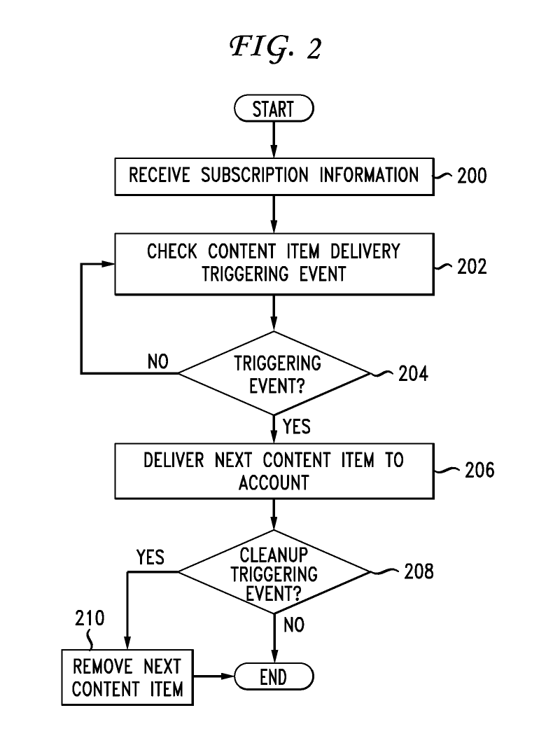

Having disclosed some basic system components and concepts, the disclosure now turns to the example method embodiments shown in FIGS. 2-5. FIG. 2 is a flowchart showing an example method for content delivery. For the sake of clarity, this method is discussed in terms of exemplary content management system 106 in FIG. 1; however the method is not limited to any specific content management system. Although specific steps are shown in FIG. 2, in other embodiments a method can have more or less steps than shown.

At step 200, content management system 106 can receive subscription information associated with an account, from a server, a user, and/or a user device. The account can include an account on content management system 106 as described above with respect to FIG. 1. The subscription information can include a queue, a content history, a content preference, a content rating, a content ranking, a content identification, a content type, a content category, a content recommendation, a content selection, and so forth. For example, the subscription information can include a list of content items identified for delivery to the account. The subscription information can also include information about a user associated with the account, such as an owner or member of the account. Information about the user can include user preferences, user details, user options, user-defined conditions, user lists, user device information, user membership, usage information, synchronization settings, user storage information, user permissions, etc.

Moreover, the content management system 106 can edit or modify the subscription information after receiving it. For example, the content management system 106 can modify the subscription information based on input from a user associated with the account. In some aspects, the content management system 106 can transmit a subscription menu to a device associated with the account, for presentation at the device. A user can then use the subscription menu to provide updated subscription information. The content management system 106 can receive the updated subscription information provided by the user and use that information to modify the subscription information. This way, a user associated with the account can manage the subscription information at any time. For example, the user can submit to the content management system 106, via the subscription menu, user management options having user-defined conditions for delivery of content items. The content management system 106 can receive the user management options with the user-defined conditions for delivery of content items, and modify the subscription information based on the user management options. The content management system 106 can then use the user-defined conditions from the subscription information to later determine when to deliver content items to the account and/or a user device, what content items to deliver, etc.

At step 202, the content management system 106 checks for a content item delivery triggering event. The content management system 106 can detect a content delivery triggering event, which triggers a delivery of a content item. The content item can be selected for delivery based on the subscription information, a user profile, an availability of the content item, a schedule, a preference, a tag, a flag, a permission, a policy, a condition, an algorithm, a similarity to other content items, a rating, a ranking, etc. The content item can include a video, a document, an image, an audio file, metadata, captions, software, revisions to a content item, a collection of files, a folder, an executable file, and so forth. For example, the content item can be an article, a song or music album, a movie, a television episode from a television series, a software patch, and so forth. Moreover, the event can trigger the delivery of the content item automatically, without input from a user.

The content delivery triggering event can include a scheduled delivery instruction, a removal of a content item from the account, an indication that a content item in the account has been accessed by a user associated with the account, an indication that the user has finished accessing a content item in the account, a request from the user, an indication that the account has sufficient storage space for the content item, a dequeuing operation, etc. For example, the triggering event can be a signal indicating that the content item is next in a queue of content items scheduled for delivery to the account and/or a user device associated with the account. As another example, the triggering event can be an indication that a previously stored content item has been removed from the account, thus freeing storage space for the content item on the account and/or opening a delivery slot or position for the content item. The triggering event can also include a product release, an availability of the content item, a release from a hold, a release from use, a release agreement, etc.

At step 204, if the content management system 106 does not detect a content delivery triggering event, it can return to step 202 to check again. On the other hand, if the content management system 106 detects a content delivery triggering event, it can for example deliver the next content item in a queue to the account at step 206. The account can then receive the content item and store it. Moreover, the account can be configured to subsequently deliver the content item to a user device. For example, the account can be configured to synchronize with a device associated with the account to deliver the content item to the device. Here, the account can synchronize with the device as previously described in FIG. 1.

The content management system 106 can deliver the content item to the account automatically, without input from a user. Similarly, the account can deliver the content item to the device automatically, without input from a user. For example, the account can deliver the content item to the device automatically after receiving it. Alternatively, the account can deliver the content item to the device automatically based on a triggering event. In both cases, the user can have content items downloaded/delivered to the user's device automatically. Here, the user does not have to spend time initiating a download and waiting for the download to complete in order to access the content item from her device when the user so desires. The user can have content items automatically downloaded to the account every time a delivery is triggered by an event, and the content can then by synchronized from the account to the user's device so the user can have the content items automatically stored on her device.

For example, the user can subscribe to the television series “Modern Family.” The content management system 106 can receive this subscription information and automatically deliver a new episode of Modern Family to the account when the new episode is released, when the user finishes watching the previous episode of Modern Family, when the user deletes a previous episode from the account, when the user removes other content items on the account, etc. Once the account receives the new episode of Modern Family, it can synchronize with the user's device to deliver the new episode to the user's device. The user can then access the new episode of Modern Family right from her device, without having to manually download the episode. The content management system 106 can continue delivering new episodes of Modern Family to the account, and the user can continue having the new episodes of Modern Family seamlessly and/or transparently downloaded to her device. As a result, the user can continue to have the new episodes of Modern Family automatically available at the device, for the user to watch when so desired. The user can similarly receive automatic downloads of other content items based on the subscription information. Moreover, the user can modify the subscription information to modify, for example, the scope and/or type of content items to be delivered to the account and the user's device. The user can also manage the content items from the user's device and/or from a menu presented by the content management system 106.

Content shared between users also can be automatically delivered to the account. For example, a user can share a video with another user associated with the account and have that video automatically delivered to the other user's device for access by the other user. Here, the content management system 106 can detect the user's request to share the video as a triggering event. In response to the user's request to share the video, the content management system 106 can automatically deliver the video to the account. The account can then synchronize the video to the other user's device so the video is automatically delivered to the other user's device. The user can receive the video at her user device without taking any action to accept the shared video. The user can also control the delivery and sharing of content through various settings (e.g., file type, sharing user, file size, account type, timing, date, etc.) so that only certain shared content is automatically delivered to the user's account and/or user's device. For example, a parent can setup their account to only automatically accept/download content shared by their kids.

The user can also cleanup content items in the account and/or the user's device at step 208. At step 208, the content management system 106 can check for a cleanup triggering event. If the content management system 106 detects a cleanup triggering event, it can remove the content item at step 210. Here, the content management system 106 can remove the content item from the account in response to the cleanup triggering event. The content management system 106 can also remove other content items at step 210, depending on the cleanup triggering event, the subscription information, cleanup rules and policies, cleanup schedules, content management system 106 status, user profile information, content settings, permissions, etc. The cleanup triggering event can trigger the cleanup and/or removal of content from the account to manage the content stored and accessible on the account. The cleanup process can help manage the space used by content on the account, restrict access to content on the account, free-up resources used by the account, update or replace content on the account, organize content on the account, etc. The cleanup triggering event can include an alert based on an expiration, an alert based on a date/schedule, a cleanup instruction, a status signal, a command, a delete request, an indication of a capacity limit, an indication of a resource status, an indication of an account status and/or restriction, a delete instruction based on a profile, a delete instruction based on a cleanup policy, a delete instruction based on a content subscription, an indication based on a flag and/or tag, a user input, etc.

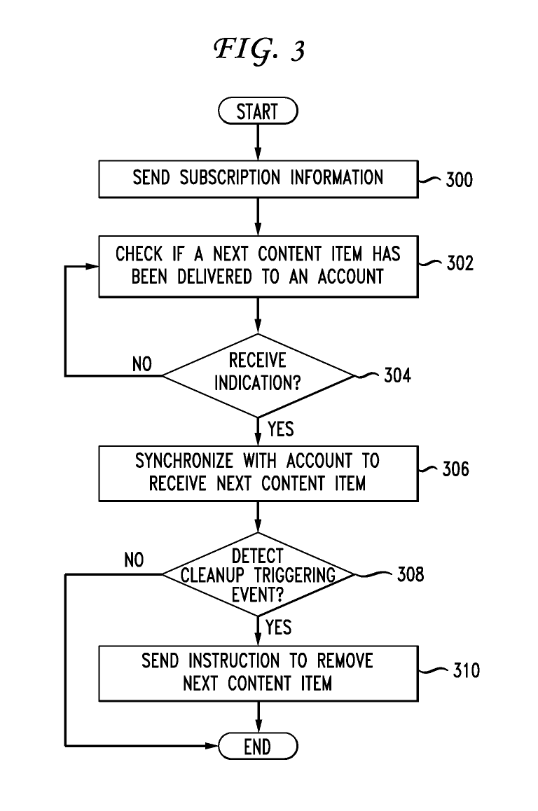

FIG. 3 is a flowchart showing an example method for receiving content. For the sake of clarity, this method is discussed in terms of an exemplary client device 102 in FIG. 1. Although specific steps are shown in FIG. 3, in other embodiments a method can have more or less steps than shown.

At step 300, the client device 102 sends subscription information associated with an account to a server. The server can be a content management server, an account server, a storage server, a database server, a content server, and/or any other type of server. The account can be, for example, an account on content management server 106, as described above in FIG. 1. The subscription information can include a queue, a content history, a content preference, a content rating, a content ranking, a content identification, a content type, a content category, a content recommendation, a content selection, and so forth. For example, the subscription information can include a list of content items identified for delivery to a user account and/or a user device. The subscription information can also include information about a user associated with the account, such as an owner or member of the account. Information about the user can include user preferences, user details, user options, user-defined conditions, user lists, user device information, user membership, usage information, synchronization settings, user storage information, user permissions, etc.

At step 302, the client device 102 checks if a content item has been delivered to the account. The content item can be selected for delivery to the account based on the subscription information. The client device 102 can automatically check if the content item has been delivered to the account according to a schedule, a policy, a condition, etc. The client device 102 can also automatically check if the content item has been delivered to the account based on a triggering event. The triggering event can include a signal from the account, a removal of a content item from the account and/or client device 102, an indication that a content item in the account and/or client device 102 has been accessed by a user associated with the account, an indication that the user has finished accessing a content item in the account and/or client device 102, an indication that the client device 102 has sufficient storage space for the next content item, an indication that a user has shared content to be delivered to the client device 102, a dequeuing operation, etc. For example, the triggering event can be a signal from the account indicating that the content item is next in a queue of content items scheduled for delivery to the client device 102. As another example, the triggering event also be an alert from the account indicating that content item has been delivered to the account. The triggering event can also include a product release, an availability of the next content item, a release from a hold, a release from use, a release agreement, etc.

At step 304, if the client device 102 determines that a next content item has not been delivered to the account, the client device 102 can return to step 302 to check again. On the other hand, if the client device 102 determines that a next content item has not been delivered to the account, it synchronizes with the account at step 306, to receive the next content item. This way, the client device 102 can automatically receive content items from the account. Moreover, the account can automatically receive the content items based on the subscription information associated with the account.

At step 308, the client device 102 can check for a cleanup triggering event to determine if any content items should be removed from the client device 102 and/or account. If the client device 102 detects a cleanup triggering event, it can send an instruction at step 310 to remove the next content item from the client device 102 and/or account. For example, in response to the cleanup triggering event, the client device 102 can execute a command on the client device 102 to remove the next content item stored on the client device 102. In response to the cleanup triggering event, the client device 102 can also send an instruction to the account to remove the next content item from the account. This way, the client device 102 can manage the content items stored on the account and/or the client device 102 and cleanup content items as necessary. The cleanup triggering event can include an alert based on an expiration, an alert based on a date/schedule, a cleanup instruction, a status signal, a command, a delete request, an indication of a capacity limit, an indication of a resource status, an indication of an account status and/or restriction, a delete instruction based on a profile, a delete instruction based on a cleanup policy, a delete instruction based on a content subscription, an indication based on a flag and/or tag, a user input, etc. The cleanup triggering event can also include an indication that the user associated with the account has finished using/accessing the next content item.

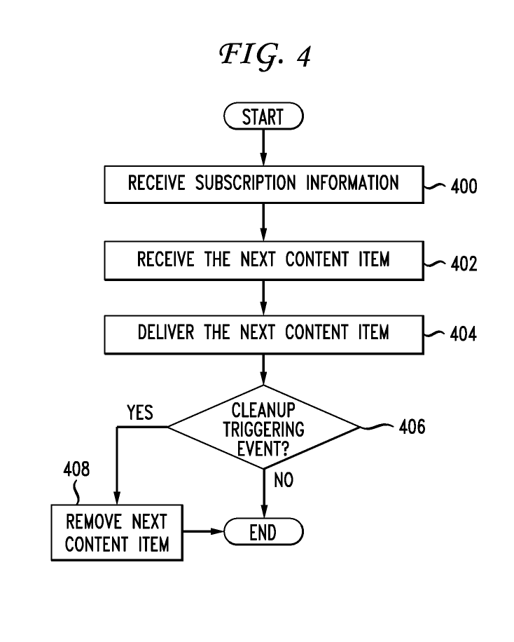

FIG. 4 shows an example flowchart for content delivery from an account. At step 400, the account receives subscription information. The account can be an account on content management system 106, as described above in FIG. 1. The subscription information can include a queue, a content history, a content preference, a content rating, a content ranking, a content identification, a content type, a content category, a content recommendation, a content selection, and so forth. For example, the subscription information can include a list of content items identified for delivery to the account and/or a user device. The subscription information can also include information about a user associated with the account, such as an owner or member of the account. Information about the user can include user preferences, user details, user options, user-defined conditions, user lists, user device information, user membership, usage information, synchronization settings, user storage information, user permissions, etc.

The subscription information can also be an update of previous subscription information. For example, the account can present a menu to a user, or transmit the menu to a user device, where the user can modify subscription information on the account. The account can then receive the modification from the user and update the subscription information on the account. This way, the user can manage her subscription information on the account and make any updates as necessary. The account can receive the subscription information from a user, a user device, a server, a different account, etc. The account can also modify the subscription information based on other information, such as data relating to content items, user data, user history, current and previous communications, user preferences, user profile information, network information, content ratings, content use, etc.

At step 402, the account receives, from a server, a next content item selected for delivery based on the subscription information. The server can be a content server, an online content store, a storage server, a file server, a user device, an online content services provider, etc. The subscription information can include a queue, a content history, a content preference, a content rating, a content ranking, a content identification, a content type, a content category, a content recommendation, a content selection, and so forth. For example, the subscription information can include a list of content items identified for delivery to the account. The subscription information can also include information about a user associated with the account, such as an owner or member of the account. Information about the user can include user preferences, user details, user options, user-defined conditions, user lists, user device information, user membership, usage information, synchronization settings, user storage information, user permissions, etc. The next content item can include a video, a document, an image, an audio file, metadata, captions, software, revisions to a content item, a collection of files, a folder, an executable file, and so forth. For example, the next content item can be an article, a song or music album, a movie, a television episode from a television series, a software patch, and so forth.

The next content item can also be selected for delivery based on a user profile, an availability of the next content item, a schedule, a preference, a tag, a flag, a permission, a policy, a condition, an algorithm, a similarity to other content items, a rating, a ranking, etc. Moreover, the account can receive the next content item in response to an event that triggers a delivery of the next content item. The event can trigger the delivery of the next content item automatically, without input from a user. The event can include a scheduled delivery instruction, a removal of a content item from the account, an indication that a content item in the account has been accessed by a user associated with the account, an indication that the user has finished accessing a content item in the account, a request from the user, an indication that the account has sufficient storage space for the next content item, a dequeuing operation, etc. For example, the event can be a signal indicating that the next content item is next in a queue of content items scheduled for delivery to the account and/or a user device associated with the account. As another example, the event can be an indication that a content item has been removed from the account, thus freeing storage space for the next content item on the account and/or opening a delivery slot or position for the next content item. The event can also include a product release, an availability of the next content item, a release from a hold, a release from use, a services schedule, a release agreement, etc.

At step 404, the account can deliver the next content item to a device associated with the account. In some embodiments, the account can deliver the next content item to a synchronized folder on the device. Here, the account can be configured to synchronize with the synchronized folder on the device to deliver the next content item and/or any other content items. The account can deliver the next content item to the device based on a request from the user and/or device. The account can also deliver the next content item to the device automatically without input from the user. For example, the account can deliver the next content item to the device after receiving the next content item from the server. The account can also deliver the next content item automatically in response to a triggering event as previously described in step 402.

At step 406, the account check for a cleanup triggering event to determine if any content items should be removed from the account. If the account detects a cleanup triggering event, remove the next content item from the account at step 408. This way, the account can manage the content items stored on the account and cleanup content items as necessary. The cleanup triggering event can include an alert based on an expiration, an alert based on a date/schedule, a cleanup instruction, a status signal, a command, a delete request, an indication of a capacity limit, an indication of a resource status, an indication of an account status and/or restriction, a delete instruction based on a profile, a delete instruction based on a cleanup policy, a delete instruction based on a content subscription, an indication based on a flag and/or tag, a lease termination, a user input, etc. The cleanup triggering event can also include an indication that the user associated with the account has finished using/accessing the next content item.

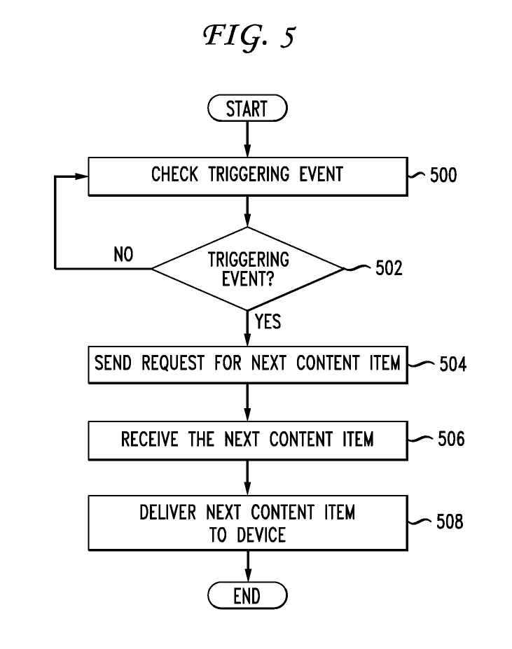

FIG. 5 shows an example flowchart for initiating content delivery. At step 500, the account can check for an event that triggers a request for delivery of a next content item to the account. The account can be, for example, an account on content management system 106, as described above in FIG. 1. The next content item to be delivered can be selected based on subscription information associated with the account. The subscription information can include a queue, a content history, a content preference, a content rating, a content ranking, a content identification, a content type, a content category, a content recommendation, a content selection, and so forth. For example, the subscription information can include a list of content items identified for delivery to the account.

The subscription information can also include information about a user associated with the account, such as an owner or member of the account. Information about the user can include user preferences, user details, user options, user-defined conditions, user lists, user device information, user membership, usage information, synchronization settings, user storage information, user permissions, etc. The next content item can include a video, a document, an image, an audio file, metadata, captions, software, revisions to a content item, a collection of files, a folder, an executable file, and so forth. For example, the next content item can be an article, a song or music album, a movie, a television episode from a television series, a software patch, and so forth.

The account can detect the event as a trigger for requesting a delivery of the next content item to the account from a server. The event can include a scheduled delivery instruction, a removal of a content item from the account, an indication that a content item in the account has been accessed by a user associated with the account, an indication that the user has finished accessing a content item in the account, a request from the user, an indication that the account has sufficient storage space for the next content item, an indication that a user has shared content to be delivered to the account, a dequeuing operation, etc. For example, the event can be a signal indicating that the next content item is next in a queue of content items scheduled for delivery to the account and/or a user device associated with the account. As another example, the event can be an indication that a content item has been removed from the account, thus freeing storage space for the next content item on the account and/or opening a delivery slot or position for the next content item. The event can also include a product release, an availability of the next content item, a release from a hold, a release from use, a service schedule, a release agreement, etc.

At step 502, if the account does not detect a triggering event, it returns to step 500. If the account does detect a triggering event, it sends the request for delivery of the next content item to a server. The account can send the request to the server automatically upon detecting the triggering event, or wait to send the request according to a schedule and/or preference. The server can be a content server, an online content store, a storage server, a file server, a user device, an online content services provider, etc. In some embodiments, the account can send the request to multiple servers. Here, the account can then select a delivery of the next content item from one or more servers. The account can select one or more servers to receive the next content item from based on various factors, such as speed, connection strength, security, quality of service, quality of the next content item at the specific server, subscription and/or service agreements, cost, user preferences, etc. For example, the account can send a request to a server selected based on an availability of the next content item at the server. Indeed, the account can send the request to a server selected based on the subscription information and/or the triggering event itself. For example, if the triggering event is a notice from a content provider or an online content store specifying that a content item has been released for access/download, the account can send the request to the sender of the notice and/or another device selected based on the notice.

At step 506, the account can receive the next content item from the server. The account can then store the next content item on the account. The account can also notify a device associated with the account that the next content item is available on the account. At step 508, the account can deliver the next content item to a device associated with the account, such as a user device. In some embodiments, the account can be configured to synchronize with the device to deliver the next content item to the device. The account can deliver the next content item to the device automatically, without input from a user. For example, the account can deliver the next content item to the device automatically after receiving the next content device from the server. The account can also deliver the next content item to the device according to a schedule. In some embodiments, the account can store the next content item and deliver it to the device in response to a triggering event, such as an event as described above with respect to step 500.

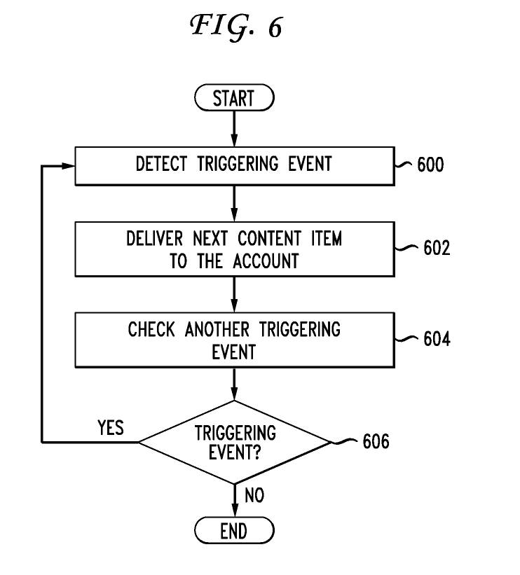

FIG. 6 is a flowchart showing steps in an example method for content delivery from a content server. For the sake of clarity, this method is discussed in terms of exemplary content server 170 in FIG. 1. Although specific steps are shown in FIG. 6, in other embodiments a method can have more or less steps than shown.

At step 600, content server 170 can detect a triggering event for delivering a next content item to an account. The account can include an account on content management system 106 as described above with respect to FIG. 1. The triggering event can trigger an automatic delivery of the next content item to the account. The triggering event can include a scheduled delivery instruction, a removal of a content item from the account, an indication that a content item in the account has been accessed by a user associated with the account, an indication that the user has finished accessing a content item in the account, a request from the user, a request from the account, an indication that the account has sufficient storage space for the next content item, an indication that a user has shared content to be delivered to the account, a dequeuing operation, etc. For example, the triggering event can be a signal indicating that the next content item is next in a queue of content items scheduled for delivery to the account and/or a user device associated with the account. As another example, the triggering event can be an indication that a content item has been removed from the account, thus freeing storage space for the next content item on the account and/or opening a delivery slot or position for the next content item. The triggering event can also include a product release, an availability of the next content item, a release from a hold, a release from use, a release agreement, etc.

In some embodiments, the triggering event can be a request from the account for a delivery of the next content item. For example, the triggering event can be a request from the account as described above in FIG. 5. In some embodiments, the triggering event can be an indication that a user has shared content to be delivered to the account. Here, the content server 170 can receive the next content item shared by a user for delivery to the account and automatically deliver the next content item to the account. The content server 170 can also receive a message, link, instruction, command, and/or signal for obtaining a shared item and delivering the shared item to the account. For example, a user can share a video with the content server 170 for delivery to another user associated with the account, so the video can then be automatically delivered to the other user's account for access by the other user. Here, the content server 170 can detect the user's request to share the video as a triggering event. In response to the user's request to share the video, the content server 170 can automatically deliver the video to the account. The account can then synchronize the video to the other user's device so the video is automatically delivered to the other user's device. Thus, the user can receive the video at her user device without taking any action to accept the shared video. The user can also control the delivery and sharing of content through various settings (e.g., file type, sharing user, file size, account type, timing, date, etc.) so that only certain shared content is automatically delivered to the user's account and/or user's device. For example, a parent can setup their account to only automatically accept/download content shared by their kids. Here, the content server 170 would only deliver content to the account that was shared by the parent's kids.

The next content item can include a video, a document, an image, an audio file, metadata, captions, software, revisions to a content item, a collection of files, a folder, an executable file, and so forth. For example, the next content item can be an article, a song or music album, a movie, a television episode from a television series, a software patch, and so forth. Moreover, the next content item can be selected for delivery to the account based on subscription information in the account. The next content item can also be selected for delivery based on other information, such as a user profile, an availability of the next content item, a schedule, a preference, a tag, a flag, a permission, a policy, a condition, an algorithm, a similarity to other content items, a rating, a ranking, etc.

The subscription information can include a queue, a content history, a content preference, a content rating, a content ranking, a content identification, a content type, a content category, a content recommendation, a content selection, and so forth. For example, the subscription information can include a list of content items identified for delivery to the account. The subscription information can also include information about a user associated with the account, such as an owner or member of the account. Information about the user can include user preferences, user details, user options, user-defined conditions, user lists, user device information, user membership, usage information, synchronization settings, user storage information, user permissions, etc.

At step 602, the content server 170 can deliver the next content item to the account, in response to the triggering event. The account can then receive the next content item and store it. Moreover, the account can be configured to subsequently deliver the next content item to a user device. For example, the account can be configured to synchronize with a device associated with the account to deliver the next content item to the device. Here, the account can synchronize with the device as previously described in FIG. 1. At step 604, the content server 170 can check for another triggering event. If the content server 170 detects another triggering event, it can return to step 600 as previously described.

The content server 170 can deliver the next content item to the account automatically, without input from a user. Similarly, the account can deliver the next content item to the device automatically, without input from a user. For example, the account can deliver the next content item to the device automatically after receiving it from the content server 170. Alternatively, the account can deliver the next content item to the device automatically based on a triggering event. In both cases, the user can have content items downloaded/delivered to the user's device automatically. Here, the user does not have to waste time initiating a download and waiting for the download to complete in order to access the content item from her device when the user so desires. The user can have content items automatically downloaded to the account every time a delivery is triggered by an event, and the content can then by synchronized from the account to the user's device so the user can have the content items automatically stored on her device.

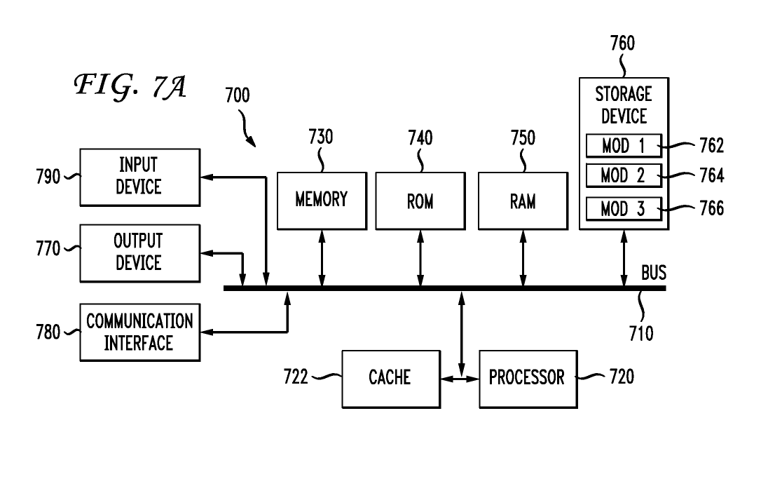

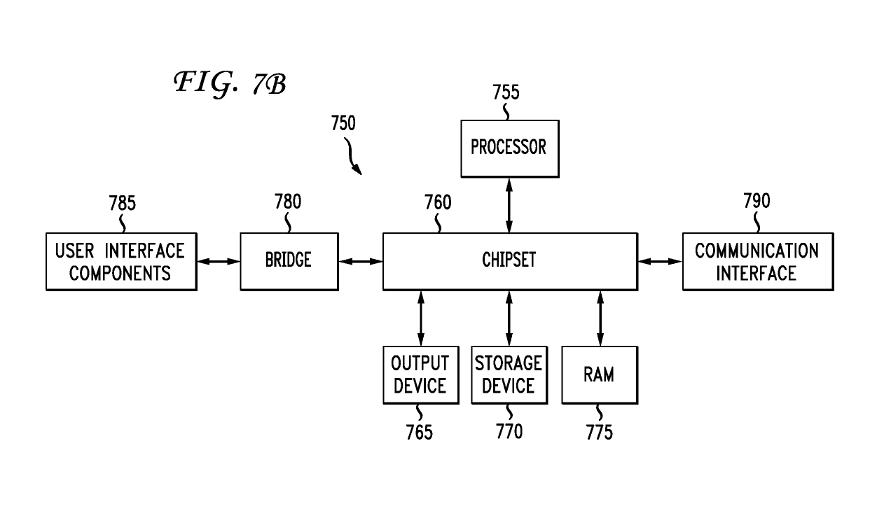

FIG. 7A, and FIG. 7B show exemplary possible system embodiments. The more appropriate embodiment will be apparent to those of ordinary skill in the art when practicing the present technology. Persons of ordinary skill in the art will also readily appreciate that other system embodiments are possible.

FIG. 7A shows a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B shows a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claim is:

1. A content-management system comprising:
at least one processor; and
a computer-readable medium having stored therein processor-executable instructions for causing a processor to:
receive subscription information associated with a content storage account;
detect a content delivery triggering event, wherein the content delivery triggering event triggers a delivery of a content item selected for delivery based at least in part on the subscription information;
deliver the content item to the account in accordance with the detection of the content delivery triggering event; and
synchronize content in the account with a device associated with the account.

2. The system of claim 1, wherein the computer-readable medium further stores processor-executable instructions for causing a processor to remove the content item from the account in accordance with detection of a cleanup triggering event.

3. The system of claim 1, wherein the computer-readable medium further stores processor-executable instructions for causing a processor to:
transmit a subscription menu to the device for presentation at the device;
receive a user management option parameter having a user-defined condition for delivery of content items; and
modify the subscription information based on the user management option parameter.

4. The system of claim 1, wherein the subscription information comprises a list of content items identified for delivery to the device associated with the account.

5. The system of claim 1, wherein the subscription information comprises at least one of a queue, a content history, a content preference, a content rating, a content ranking, a content identification, a content type, a content category, a content recommendation, or a content selection.

6. The system of claim 1, wherein the event comprises at least one of a scheduled delivery instruction, a release of the content item, a removal of a content item from the account, an indication that the content item in the account has been accessed by a user, an indication that the user has finished accessing the content item in the account, a request from the user, an indication that the account has sufficient storage space for the content item, or a dequeuing operation.

7. The system of claim 1, further comprising synchronizing the account with a second device associated with the account to deliver the content item to the second device.

8. The system of claim 1, wherein the content item comprises at least one of a video, a document, an image, an audio file, metadata, captions, software, or revisions to a content item.

9. A computer-implemented method comprising:
sending, by a processor, subscription information associated with an account to a server;
receiving, by a processor, an indication that a content item has been delivered to the account by the server, wherein the content item is selected for delivery based on the subscription information; and
synchronizing, by a processor, with the account to receive the content item from the account in accordance with the indication.

10. The computer-implemented method of claim 9, further comprising, after receiving the next content item from the account, sending an instruction to remove the next content item from the account, wherein the instruction is based on a cleanup triggering event.

11. The computer-implemented method of claim 9, wherein the subscription information comprises at least one of a queue, a content history, a content preference, a content rating, a content ranking, a content identification, a content type, a content category, a content recommendation, or a content selection.

12. The computer-implemented method of claim 9, further comprising:
receiving, by a processor, a subscription menu associated with the account; and
sending to the account, by a processor, a user management option having a user-defined condition for delivery of content items, wherein the user management option instructs the account to modify the subscription information according to the user-defined condition for delivery of content items.

13. The computer-implemented method of claim 9, wherein the next content item comprises at least one of a video, a document, an image, an audio file, metadata, captions, software, or revisions to a content item.

14. A computer-readable medium having stored therein processor-executable instructions for causing a processor to:
receive subscription information associated with a content storage account;
detect a content delivery triggering event, wherein the content delivery triggering event triggers a delivery of a content item selected for delivery based at least in part on the subscription information;
deliver the content item to the account in accordance with the detection of the content delivery triggering event; and
synchronize content in the account with a device associated with the account.

15. The computer-readable medium of claim 14, wherein the content item is received from a content-management server associated with the account.

16. The computer-readable medium of claim 14, storing additional processor-executable instructions for causing a processor to:
transmit a subscription menu to the device for presentation at the device;
receive a user management option having a user-defined condition for delivery of content items; and
modify the subscription information based on the user management option.

17. The computer-readable medium of claim 14, storing additional processor-executable instructions for causing a processor to remove the content item from the account based on a cleanup triggering event.

18. A computer-readable medium storing processor-executable instructions for causing a processor to:
detect an event that triggers a request for delivery of a content item to an account, wherein the content item is selected for delivery based on subscription information associated with the account;
send to a server the request for delivery of the content item; and
receive at the account the content item from the server, wherein the account is configured to synchronize with a device associated with the account.

19. The computer-readable medium of claim 18, storing additional processor-executable instructions for causing a processor to deliver the next content item to the device associated with the account.

20. The computer-readable medium of claim 18, wherein the subscription information comprises at least one of a queue, a content history, a content preference, a content rating, a content ranking, a content identification, a content type, a content category, a content recommendation, or a content selection.
